(19) United States
(12) Patent Application Publication
(10) Pub. No.: US 2011/0038009 A1
(43) Pub. Date: Feb. 17, 2011

(54) Method and System for Compensating Imaging Defect in Image Forming Apparatus

(76) Inventors: Brian Edward Cooper, Lexington, KY (US); Ahmed Hamad Mohamed Eid, Lexington, KY (US); Jian Wen, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/540,458

(22) Filed: Aug. 13, 2009

(51) Int. Cl. G06K 15/02

(52) U.S. Cl. 358/3.06; 358/3.26; 358/1.16

(57) ABSTRACT

Disclosed is a method for compensating an imaging defect in an image forming apparatus. The method includes generating a raster image. Further, the method includes determining a compensating profile representing the imaging defect in the image forming apparatus. Furthermore, the method includes forming a defect-compensated image based on the raster image and the compensating profile. Also, disclosed is the image forming apparatus capable of compensating the imaging defect thereof.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to image forming apparatuses, and more particularly, to compensating imaging defects in the image forming apparatuses.

2. Description of the Related Art

During operation of an image forming apparatus, such as a laser printer, a copying machine, and a multifunctional peripheral, various imaging defects may appear in images rendered by the image forming apparatus. These imaging defects considerably reduce the quality of the images that might leave users of the image forming apparatus unsatisfied with the quality of the image.

One such imaging defect is known as a ‘clouding defect.’ The clouding defect is recognized by the appearance of a repeating ‘clouding pattern’ in the images rendered by the image forming apparatus. The clouding defect primarily occurs due to non-uniformity in thickness of a Photoconductor (PC) drum of the image forming apparatus, and more specifically, on a charge transport layer (CTL) of the PC drum. Moreover, the clouding defect may also occur due to wear and tear of the CTL of the PC drum after a prolonged usage of the PC drum, and due to environmental conditions existing in a place, where the image forming apparatus is operated.

In addition to directly reducing the quality of the images, such imaging defects may cause various indirect effects. One such indirect effect may be wastage of resources during manufacturing of the image forming apparatus. This effect may be understood by considering the fact that during manufacturing of the PC drums, some PC drums are discarded if they exhibit a clouding defect exceeding a particular threshold value during testing. Discarding the PC drums clearly wastes resources. In order to reduce the waste of resources, manufacturers have been employing an expensive fabrication process, which minimizes the wasting of resources. However, the use of the expensive fabrication process results in an increase of manufacturing costs for the manufacturers.

Moreover, the clouding defect intensifies with time. Once the clouding defect becomes sufficiently severe, the typical solution is to simply replace the PC drum of the image forming apparatus, which may prove very expensive for the user of the image forming apparatus.

Therefore, there is a need for compensating the clouding defect in the image forming apparatus. More specifically, there is a need for decreasing the maintenance costs of the image forming apparatus, and enhancing the quality of imaging in the image forming apparatus. Further, there is a need to lower manufacturing costs associated with the manufacturing of PC drums by accepting use of less than uniform PC drums in the image forming apparatus, without suffering from reduced image quality caused by the imaging defects.

### SUMMARY OF THE DISCLOSURE

In view of the foregoing disadvantages inherent in the prior art, the general purpose of the present disclosure is to provide a method for compensating an imaging defect in an image forming apparatus, to include all the advantages of the prior art, and to overcome the drawbacks inherent therein.

In one aspect, the present disclosure provides a method for compensating the imaging defect of the image forming apparatus. The method includes generating a raster image. Further, the method includes determining a compensating profile representing the imaging defect in the image forming apparatus. Thereafter, the method includes forming a defect-compensated image based on the raster image and the compensating profile.

In another aspect, the present disclosure relates to an image forming apparatus capable of compensating an imaging defect thereof. The image forming apparatus includes a determining module configured to determine a compensating profile representing the imaging defect in the image forming apparatus. Further, the image forming apparatus includes an image processing module coupled to the determining module. The image processing module is configured to generate a raster image. Further, the image processing module is configured to form a defect-compensated image based on the raster image and the compensating profile.

### BRIEF DESCRIPTION OF THE DRAWINGS

The above-mentioned and other features and advantages of this present disclosure, and the manner of attaining them, will become more apparent and the present disclosure will be better understood by reference to the following description of embodiments of the present disclosure taken in conjunction with the accompanying drawings, wherein:

FIG. 1 is a flow diagram of a method for compensating an imaging defect in an image forming apparatus, according to an embodiment of the present disclosure;

FIG. 2 is a flow diagram of a method for determining a compensating profile representing the imaging defect in the image forming apparatus, according to an embodiment of the present disclosure;

FIG. 3 depicts a flow diagram of a method for forming a defect-compensated image based on a raster image and the compensating profile, according to an embodiment of the present disclosure;

FIG. 4 depicts a flow diagram of a method for forming the defect-compensated image based on the raster image and the compensating profile, according to another embodiment of the present disclosure;

FIG. 5 depicts a block diagram of an image forming apparatus capable of compensating the imaging defect therein, according to an embodiment of the present disclosure;

FIG. 6 depicts an image processing module, according to an embodiment of the present disclosure;

FIG. 7 depicts the image processing module, according to another embodiment of the present disclosure;

FIG. 8a depicts a full-page print corresponding to the imaging defect in the image forming apparatus;

FIG. 8b depicts an electronic profile of the full-page print of FIG. 8a;

FIG. 9a depicts a compensating profile corresponding to the full-page print of FIG. 8a;

FIG. 9b depicts a defect-compensated image obtained corresponding to the full-page print of FIG. 8a; and

FIG. 10 depicts distribution of values of ΔL* for the full-page print of FIG. 8a and for the defect-compensated image of FIG. 9b.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. Further, the use of terms “first”, “second”, and “third”, and the like, herein do not denote any order, quantity, or importance, but rather are used to distinguish one element from another. Moreover, the terms “a” and “an” herein do not denote a limitation of quantity, but rather denote the presence of at least one of the referenced item.

The present disclosure provides a method for compensating an imaging defect in an image forming apparatus. It will be apparent to those skilled in the art that the term ‘image forming apparatus’ mentioned herein refers to devices used for generating an image on a physical media. Suitable example of such devices may include, but are not limited to, a laser printer, a copying machine, and a multifunctional peripheral. Suitable examples of the physical media may include, but are not limited to, paper, textiles substrates, non-woven substrates, canvas substrates, and cellulose substrates. Further examples of the physical media may also include a physical material such as an intermediate transfer belt present inside the image forming apparatus. The intermediate transfer belt may be employed in the image forming apparatus for providing at least one of a dynamic tone correction and a compensation of a clouding defect in a Photoconductor (PC) of the image forming apparatus.

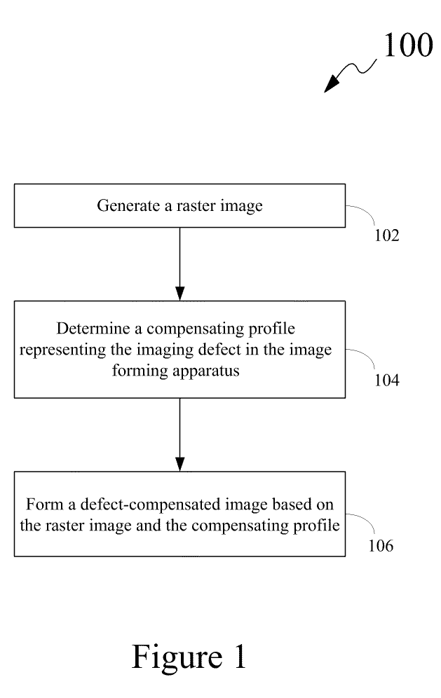

The method of the present disclosure will now be explained in detail with reference to FIG. 1.

FIG. 1 depicts a flow diagram of a method 100 for compensating an imaging defect in an image forming apparatus, according to an embodiment of the present disclosure. The term ‘imaging defect’ mentioned herein may refer to a clouding defect, which usually occurs due to non-uniformity of a surface of a PC drum of the image forming apparatus. Accordingly, the terms ‘imaging defect’ and ‘clouding defect’ may interchangeably be used throughout the detailed description.

Though the present disclosure applies to compensating the clouding defect in the image forming apparatus, it should not be construed as a limitation to the present disclosure. The present disclosure may also be applied for compensating other imaging defects in the image forming apparatus. For example, the present disclosure may be applied for compensating “ghosting” or “residual image” defects in the image forming apparatus.

Method 100 includes generating a raster image, at 102. The term ‘raster image’ mentioned herein refers to output of a Raster Image Processor module (hereinafter referred to as ‘RIP module’) present in a typical image forming apparatus. More specifically, it will be apparent to a person skilled in the art that during a process of imaging inside the image forming apparatus, the RIP module converts a print data into a series of bits of information, which represents pixels of the image. Such a series of bits of information is referred as the ‘raster image.’

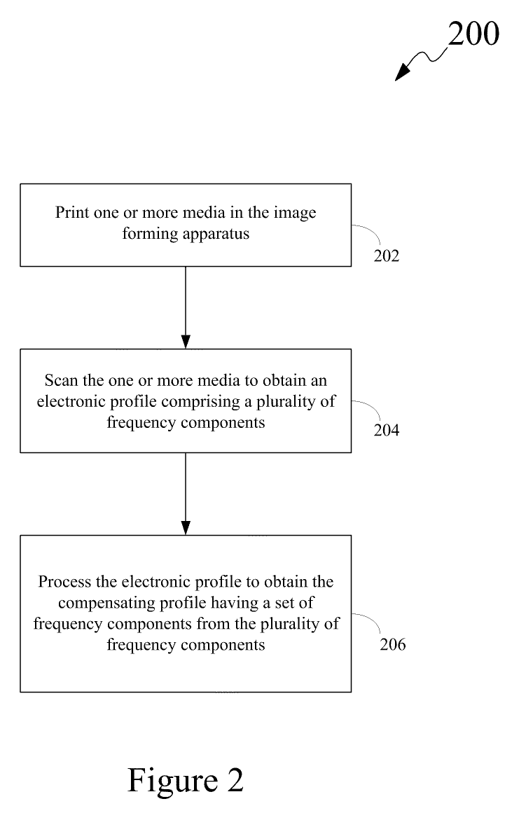

Method 100 further includes determining a compensating profile representing the imaging defect in the image forming apparatus, at 104. The term ‘compensating profile’ as mentioned herein refers to a data set generated corresponding to the imaging defect in the image forming apparatus. In an embodiment of the present disclosure, the determination of the compensating profile representing the imaging defect is explained in detail with reference to FIG. 2.

FIG. 2 depicts a flow diagram of method 200 for determining the compensating profile, according to an embodiment of the present disclosure. As depicted in FIG. 2, method 200 includes printing one or more physical media (hereinafter referred to as ‘media’) in the image forming apparatus, at 202. It should be understood that the term ‘media’ as mentioned herein may refer to one or more media sheets having predefined levels of toning. For the purpose of this description, the media sheets may have the predetermined levels of toning of about 30 percent, 50 percent, or 70 percent of the area of the media sheets. It should be understood that such printing of the media having varied levels of toning generates a sample set of the imaging defect, which may then be employed in determining the compensating profile as described later in the detailed description.

Further, as shown in FIG. 2, method 200 includes scanning the media, at 204. It should be understood that the scanning of the media converts the images of the imaging defect on the media into an electronic profile, which is a digital representation thereof. Further, it should be understood that such an electronic profile may have a plurality of frequency components therein.

In order to extract the compensating profile from the electronic profile, method 200 further includes processing the electronic profile, at 206. In an embodiment of the present disclosure, method 200 may extract a set of frequency components by filtering the plurality of frequency components of the electronic profile. Such filtering of the plurality of frequency components extracts the set of frequency components generating the compensating profile.

The clouding defect, as mentioned herein, tends to occur within a range of frequencies, such as lower spatial frequencies. Accordingly, method 200 may filter higher spatial frequencies of the electronic profile, and retain only the lower spatial frequencies to obtain the compensating profile. For the purpose of this description, method 200 may retain frequencies in a range of about 0.25 cycles/inch to about 5.0 cycles/inch for obtaining the compensating profile. Without limiting the scope of the present invention, a wavelet filtering may be used to retain the lower spatial frequencies.

In an alternate embodiment of the present disclosure, the compensating profile may be determined by imaging a surface of the PC drum, using eddy currents. More specifically, eddy currents across the surface of the PC drum may be traced. The tracing of the eddy currents may produce an image of a thickness profile of the charge transport layer, which may represent the imaging defect on the surface of the PC drum. Such an image may be further processed to obtain the compensating profile. It will be apparent to a person skilled in the art that such a determination by imaging of the PC drum may not require the printing and scanning of one or more especially designed media in the image forming apparatus.

Method 200 may further include storing the compensating profile in a memory of the image forming apparatus. It should be understood that due to the presence of low frequency components in the compensating profile, it may be stored in the memory of the image forming apparatus at a resolution less than that of the image forming apparatus. Further, it will be apparent to a person skilled in the art that the storing of the compensating profile at a lower resolution may lead to compression of a size of the compensating profile, thereby reducing an amount of memory required for the storage thereof.

Further, it should be understood that the memory of the image forming apparatus may be physically located inside the image forming apparatus. For example, the compensating profile may be stored in the memory of the RIP module of the image forming apparatus. In an alternate embodiment of the present disclosure, the compensating profile may be stored in a storage location external to the image forming apparatus. For example, the compensating profile may be stored in a memory of a device, which scans and prints the one or more media. In such an embodiment, method 200 may include receiving the compensating profile from the storage location.

In another embodiment of the present disclosure, method 200 may determine the compensating profile dynamically. Such an embodiment, therefore, may not require the storing of the compensating in the memory of the image forming apparatus, or the storage location external to the image forming apparatus.

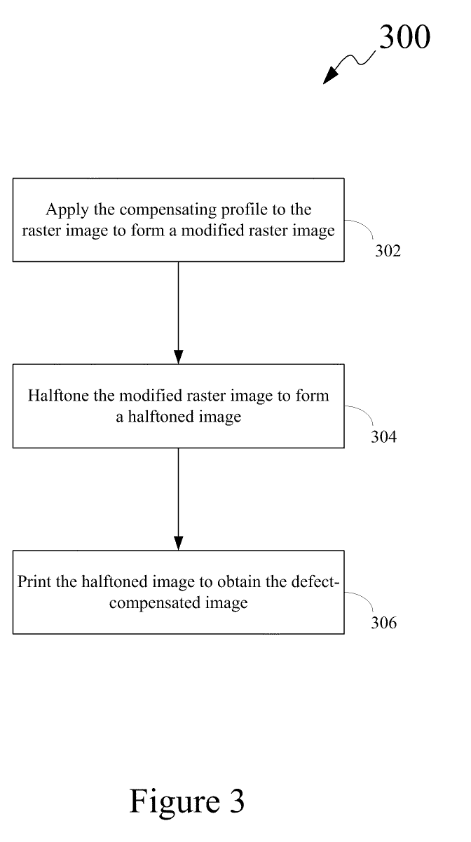

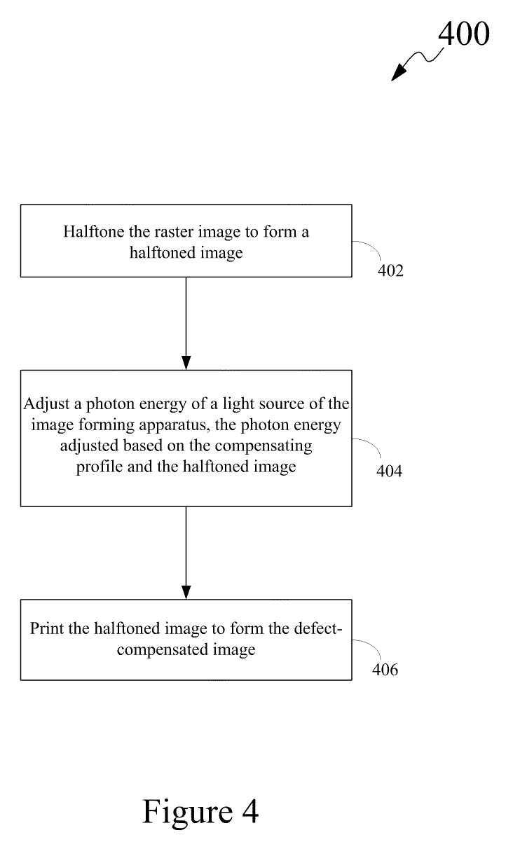

Now referring again to FIG. 1, method 100 further includes forming a defect-compensated image based on the raster image and the compensating profile, at 106. Embodiments of the formation of the defect-compensated image are explained in detail with respect to FIGS. 3 and 4.

FIG. 3 depicts a flow diagram of method 300 for forming the defect-compensated image based on the raster image and the compensating profile, according to an embodiment of the present disclosure. It should be clearly understood that in one embodiment of the present invention, the method 300 is used for the formation of the defect-compensated image at 106 of FIG. 1. Method 300 includes applying the compensating profile to the raster image to form a modified raster image, at 302. More specifically, method 300 includes applying the compensating profile to pre-halftoned image pixel values of the raster image, at 302. It will be apparent to a person skilled in the art that the term ‘pre-halftoned image pixel values’ herein refers to a continuous-tone raster image having about 8 Bits Per Pixel (BPP) generated by a typical RIP module.

However, before applying the compensated profile to the raster image, method 300 may include identifying a predetermined position of the PC drum. Such an identification of the predetermined position may be necessary for synchronizing the PC drum with the RIP module of the image forming apparatus. More specifically, the identification of the predetermined position enables applying the compensating profile in a same phase as that of the imaging of the image forming apparatus.

In an embodiment of the present disclosure, the predetermined position of the PC drum may be a home position of the PC drum. It will be apparent to a person skilled in the art that during the imaging, the PC drum is aligned at a predefined position before generating the printed image on a media sheet. Such a position of the PC drum may be referred to as the ‘home position’ of the PC drum. Further, the ‘predetermined position’ may interchangeably be referred to as the ‘home position’ throughout the detailed description.

Further, it will be apparent to a person skilled in the art that the compensating profile may be retrieved from the memory of the image forming apparatus or from the storage location external to the image forming apparatus before applying the compensating profile on the raster image. Moreover, due to the contraction of the compensating profile during storage of the compensating profile, it may be necessary to enlarge the compensating profile before the compensating profile is applied to the raster image.

It should be clearly understood that the formation of the modified raster image at 302 compensates the imaging defect in the image forming apparatus. Therefore, method 300 may further include halftoning the modified raster image to form a halftoned image, at 304. It will be apparent to a person skilled in the art that the term ‘halftoning’ mentioned herein refers to a process of representing a continuous image using a plurality of dots. Further, it will be apparent to a person skilled in the art that the term ‘halftoned image’ refers to a raster image having fewer Bits Per Pixel (BPP) than the continuous-tone image. Typically, the RIP module generates a raster image with 1 BPP, 2 BPP, or 4 BPP.

After the halftoning, method 300 may include printing the halftoned image to obtain the defect-compensated image, at 306. It should be understood that such a printing may be performed by creating an electrostatic latent image corresponding to the defect-compensated image on the surface of the PC drum, and then transferring and fixing the electrostatic latent image to the media sheet to get the printed image.

In another embodiment of the present disclosure, method 300 includes forming the defect-compensated image after a halftoning of the raster image in the image forming apparatus. Such an embodiment is now explained in detail with reference to FIG. 4.

FIG. 4 depicts a flow diagram of method 400 for forming the defect-compensated image based on the raster image and the compensating profile, according to another embodiment of the present disclosure. It should be clearly understood that in another embodiment of the present invention, method 400 is used for the formation of the defect-compensated image at 106 of FIG. 1. Method 400 includes halftoning the raster image to form a halftoned image, at 402. Further, method 400 includes adjusting a photon energy of a light source of the image forming apparatus, at 404. It should be apparent to a person skilled in the art that a typical image forming apparatus usually includes the light source for photo-generating a charge on a surface of the PC drum. Moreover, such light source emits photon energy (electromagnetic radiation) having a wavelength in accordance with spectral sensitivity of the PC drum. An example of the light source may include a light emitting diode (LED) emitting visible light. However, the example mentioned herein should not be construed as a limitation to the present disclosure. The present disclosure may employ other light sources, such as an ultraviolet light, and an infrared light, for photo-generating the charge on the PC drum.

In an embodiment of the present disclosure, the adjustment of the photon energy of the light source may be based on the compensating profile representing the imaging defect. More specifically, the adjustment of the photon energy may be based on a mathematical model derived from the compensating profile. An exemplary mathematical model, which may be implemented for adjusting the photon energy of the light source, is described later in detail in this description.

Method 400 further includes printing the halftoned image to form the defect-compensated image, at 406. It should be understood that such a printing may be similar to the printing described with reference to method 300 of FIG. 3.

However, before printing the halftoned image to form the defect-compensated image, at 406, method 400 may include identifying a predetermined position of the PC drum for synchronizing the PC drum with a Raster Image Processor (RIP) module of the image forming apparatus. It should be understood that the term ‘predetermined position’ herein refers to the home position of the PC drum, as described with reference to FIG. 3.

Further, it should be understood that the compensating profile may be retrieved from the memory of the image forming apparatus, or from the storage location, before adjusting the photon energy of the light source. Moreover, due to the contraction of the compensating profile during storage thereof, it may be necessary to enlarge the compensating profile before applying the compensating profile to the raster image. After the adjustment of the photon energy, method 400 includes printing the halftoned image to form the defect-compensated image. It should be understood that such a printing may be similar to the printing described with reference to FIG. 3.

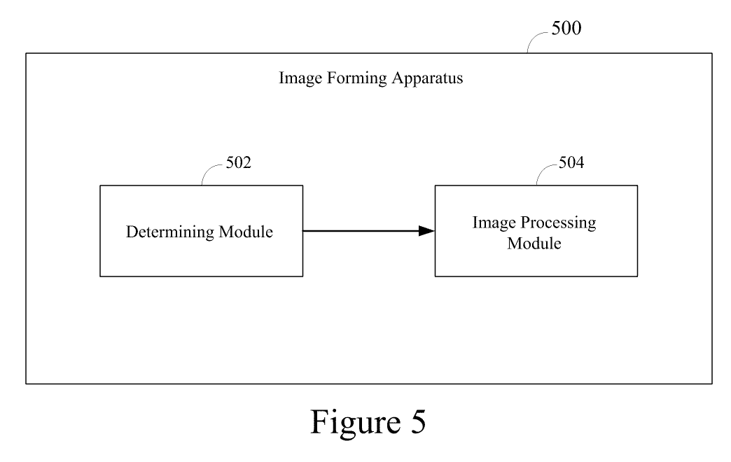

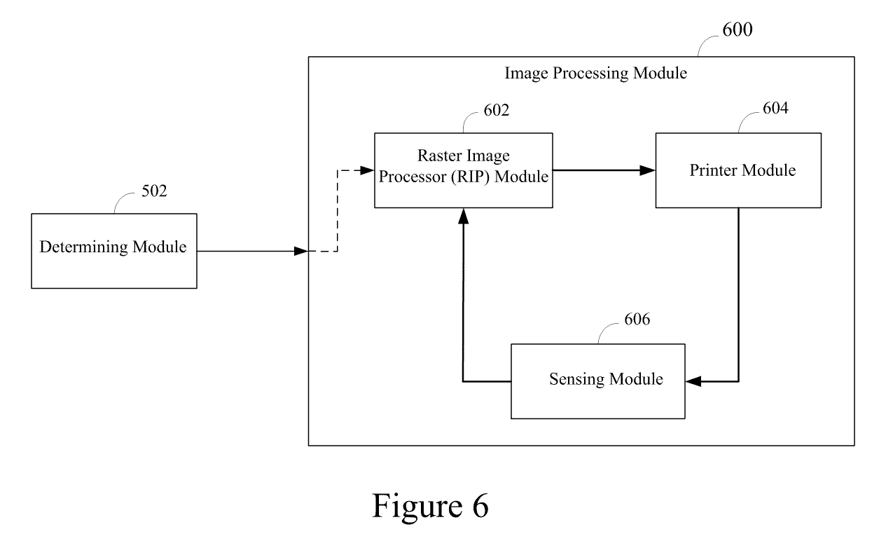

Method 100 of the present disclosure may be better understood by considering an image forming apparatus, where method 100 may be utilized for compensating the imaging defect. Such an image forming apparatus is now described in detail with reference to FIGS. 5 and 6.

FIG. 5 depicts a block diagram of an image forming apparatus 500 capable of compensating an imaging defect thereof, according to an embodiment of the present disclosure. As shown in FIG. 5, image forming apparatus 500 includes a determining module 502. It should be understood that determining module 502 mentioned herein may implement a method such as method 200 as described with reference to FIG. 2.

Therefore, determining module 502 may be configured to print one or more media in image forming apparatus 500. Further, determining module 502 may be configured to scan these one or more media to obtain an electronic profile. It should be understood that the electronic profile may require a further processing for obtaining the compensating profile. Accordingly, determining module 502 may be configured to process the electronic profile to obtain the compensating profile. Moreover, it should be understood that determining module 502 may process the electronic profile as described with reference to method 200 of FIG. 2.

Further, it will be apparent to a person skilled in the art that the compensating profile may require storage in a memory during the compensation of the imaging defect in image forming apparatus 500. Thus, image forming apparatus 500 may include a memory (not shown) for providing storage of the compensating image therein.

In another embodiment of the present disclosure, determination of the compensating profile may be done by an electronic device that is external to image forming apparatus 500. The external device may print and scan the media, and accordingly calculate the compensating profile. In this embodiment, determining module 502 may act as a ‘receiving module 502’ configured to receive the compensating profile from the electronic device external to image forming apparatus 500.

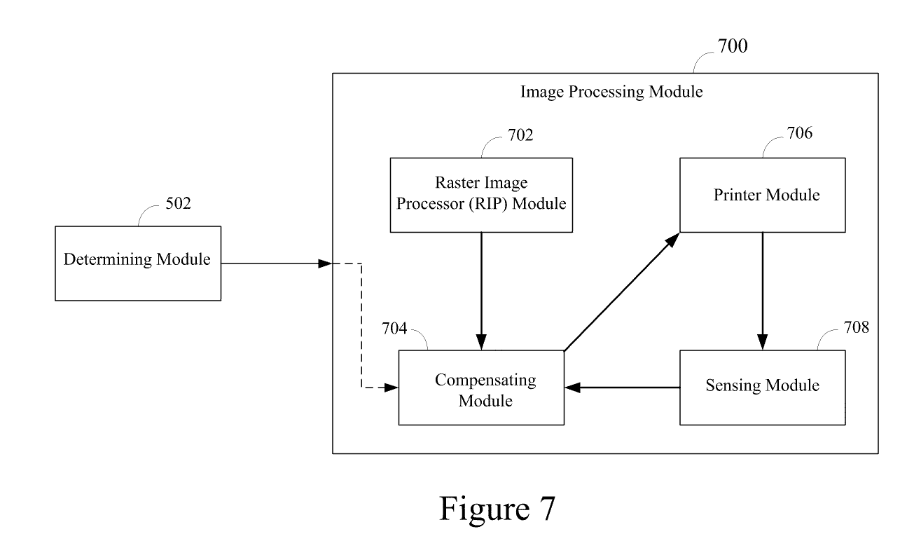

Further, image forming apparatus 500 includes an image processing module 504 coupled to determining module 502. Image processing module 504 may be configured to generate a raster image, and form a defect-compensated image based on the raster image and the compensating profile. Embodiments of image processing module 504 will now be explained in detail as image processing module 600 with reference to FIG. 6 and image processing module 700 with reference to FIG. 7.

In one embodiment of the present invention, image processing module 504 of image forming apparatus 500 is represented as an image processing module 600 in FIG. 6, where image processing module 600 is shown in communication with determining module 502. Referring to FIG. 6, image processing module 600 includes a Raster Image Processor module 602 (hereinafter referred to as ‘RIP module 602’), a printer module 604, and a sensing module 606.

It should be understood that RIP module 602 may be a hardware component, a software component of an operating system, or a firmware program implemented on the hardware component. RIP module 602 is configured to generate a raster image in an image forming apparatus, such as image forming apparatus 500. More specifically, RIP module 602 may be configured to receive a print data corresponding to an image from a user of the image forming apparatus, and convert the print data into the raster image. It will be apparent to a person skilled in the art that the print data is usually in the form of a high-level page description language, such as a PostScript language, and a Portable Document Format language. Further, RIP module 602 may be configured to receive the compensating profile representing the imaging defect from determining module 502 as described with reference to FIG. 5.

RIP module 602 may be further configured to apply the compensating profile to the raster image, and more specifically, to the pre-halftoned image pixel values of the raster image. The RIP module 602 generates a modified raster image by applying the compensating profile to the pre-halftoned image pixel values. Moreover, RIP module 602 is further configured to halftone the modified raster image to form a halftoned image.

To convert the halftoned image into a defect-compensated image, printer module 604 is coupled to RIP module 602. Printer module 604 receives the halftoned image from RIP module 602, and prints the halftoned image to form the defect-compensated image. Such printing is already described with reference to FIGS. 3 and 4 above. It would be apparent to a person ordinarily skilled in the art that in one embodiment, printer module 604 may be similar to a conventional printer module usually employed inside a typical image forming apparatus. More specifically, printer module 604 may include components, such as a light source, a charge roller, and a PC drum for creating an electrostatic latent image of the halftone image, and fixing rollers for converting the electrostatic latent image into the defect-compensated image.

Sensing module 606 is coupled to RIP module 602 and printer module 604. Sensing module 606 may be configured to identify the home position of the PC drum of

In another embodiment of the present disclosure, the image processing module 504 is represented as an image processing module 700 in FIG. 7, where image processing module 700 is shown in communication with determining module 502. Image processing module 700 includes a Raster Image Processor module 702 (hereinafter referred to as ‘RIP module 702’), a compensating module 704, a printer module 706, and a sensing module 708. RIP module 702 may be configured to generate a raster image. Further, RIP module 702 may be configured to halftone the raster image to form a halftoned image.

Compensating module 704 is coupled to RIP module 702. Compensating module 704 may be configured to receive the compensating profile representing the imaging defect, from determining module 502. Further, compensating module 704 may be configured to adjust a photon energy of a light source of image forming apparatus 500. It should be understood that compensating module 704 may be configured to adjust the photon energy based on the compensating profile received from determining module 502. More specifically, compensating module 704 may be configured to adjust the photon energy of the light source based on a mathematical model derived from the compensating profile. Moreover, it should be understood that compensating module 704 may employ a controller system, which may adjust the photon energy of the light source based on the mathematical model. An exemplary mathematical model is described in detail later in the detailed description.

Printer module 706, which is coupled to compensating module 704, is similar to printer module 604 described with reference to FIG. 6. Therefore, printer module 704 may be configured to print the halftoned image to form the defect-compensated image.

Sensing module 708 is coupled to compensating module 704 and printer module 706. Sensing module 708 may be configured to identify the home position of the PC drum of an image processing apparatus, such as image forming apparatus 500. More specifically, sensing module 708 may include a sensing mechanism, which senses the home position of the PC drum of the image processing apparatus. It should be understood that sensing module 708, after determining the predetermined position, may send the information about the home position as a feedback to compensating module 704 coupled thereto. As described above, the receipt of the information about the predetermined position by compensating module 704 may allow for the compensation of the imaging defect by compensating module 704 in a same phase as that of the PC drum.

The foregoing embodiments of the present disclosure may further be understood by referring to the following non-limiting examples. However, one of ordinary skill in the art, and based on a reading of this detailed description, would recognize that, the specific example is intended to illustrate, not limit, the scope of the present disclosure.

### EXAMPLE

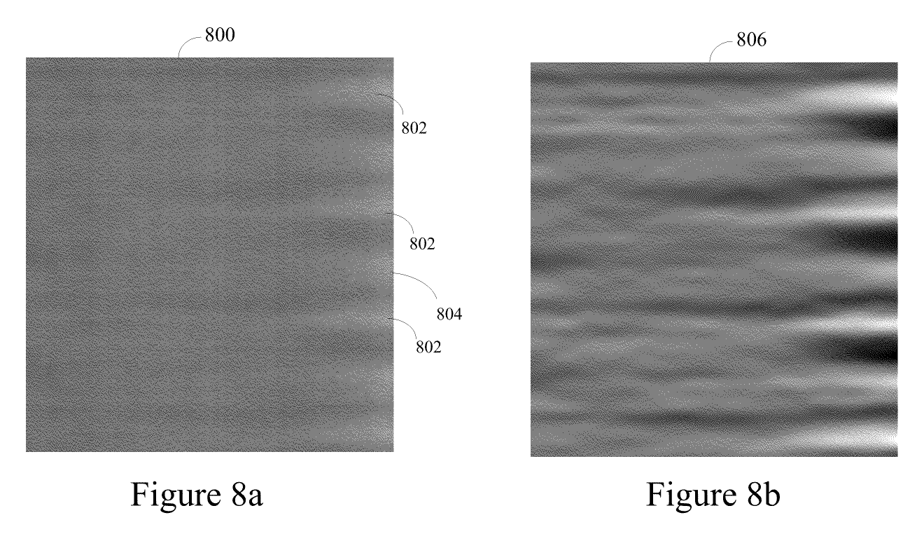

In the following example, the method of the present disclosure, such as method 100, was investigated in an image forming apparatus for compensating an imaging defect therein. Such an investigation will now be described with reference to FIGS. 8a, 8b, 9a, 9b, and 10.

FIG. 8a depicts a full-page print 800 by the image forming apparatus. Full page print 800 represents an original printing by the image forming apparatus including the imaging defects. In this investigation, full-page print 800 is of constant gray level, and has average lightness (L*) of about 50 L*. It will be apparent to a person skilled in the art that the term ‘average lightness’ mentioned herein refers to a perception of darkness of an image as detected by a human eye or measured by an apparatus, such as a reflection densitometer. Accordingly, the average lightness of 50 L* refers to a perceived darkness of about 50 percent by the human eye or the reflection densitometer.

As depicted in FIG. 8a, full-page print 800 includes clouding detects represented by a plurality of clouding spots 802 (hereinafter referred to as ‘clouding spots 802’) at a first edge 804 of full-page print 800. It will be evident that such clouding spots 802 are lighter in intensity as compared to the rest of full-page print 800. It should be understood that such clouding spots 802 represent the clouding defect existing in the image forming apparatus. Moreover, it should be understood that method 100, as described above, may compensate these clouding spots 802 to form a defect-compensated image in the image forming apparatus.

Further, FIG. 8b depicts an electronic profile 806 of full-page print 800. It should be clearly understood that electronic profile 806 may be obtained as described with reference to method 200 of FIG. 2. Moreover, it should be understood that electronic profile 806 may represent a difference of average lightness (hereinafter referred to as ‘ΔL*’) between clouding spots 802 and average lightness of full-page print 800. For the purpose of this example, the ΔL* ranges from about −7 and about +7. In an embodiment of the present invention, electronic profile 806 may be generated after performing a wavelet filtering to extract the compensating profile

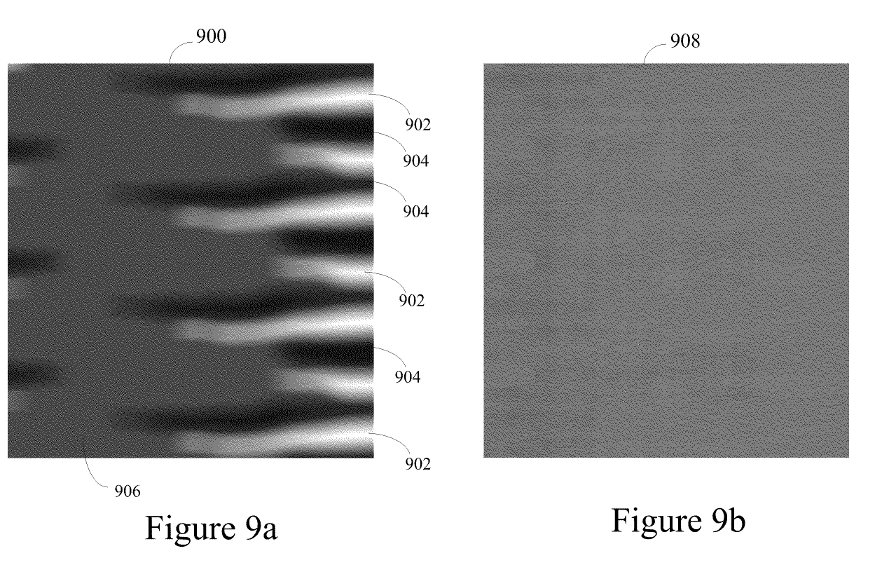

FIG. 9a depicts a compensating profile 900 corresponding to full-page print 800 of FIG. 8a. Compensating profile 900 is obtained from electronic profile 806. It should be understood that compensating profile 900 herein represents the imaging defect in the image forming apparatus. Further, it should be clearly understood that compensating profile 900 may be determined as mentioned with reference to method 200 of FIG. 2. Further, it should be clearly understood that compensating profile 900 is employed for compensating the imaging defect of the image forming apparatus.

As depicted in FIG. 9a, plurality of first spots 902 (hereinafter referred to as ‘first spots 902’) represents spots having positive values of ΔL*, and plurality of second spots 904 (hereinafter referred to as ‘second spots 904’) represents spots having negative values of ΔL*, in compensating profile 900. Accordingly, first spots 902 and second spots 904 require a compensation of the imaging defect. Moreover, as depicted in FIG. 9a, a first area 906 represents negligible values of ΔL*. Accordingly, first area 906 may not require a compensation of the imaging defect.

FIG. 9b depicts a defect-compensated image 908 obtained corresponding to full-page print 800 of FIG. 8a. It should be clearly understood that defect-compensated image 908 is obtained as described with reference to method 100 of FIG. 1. It may be evident from FIG. 9b that the imaging defect appearing in full page print 800 of FIG. 8a, has been compensated in the defect-compensated image 908.

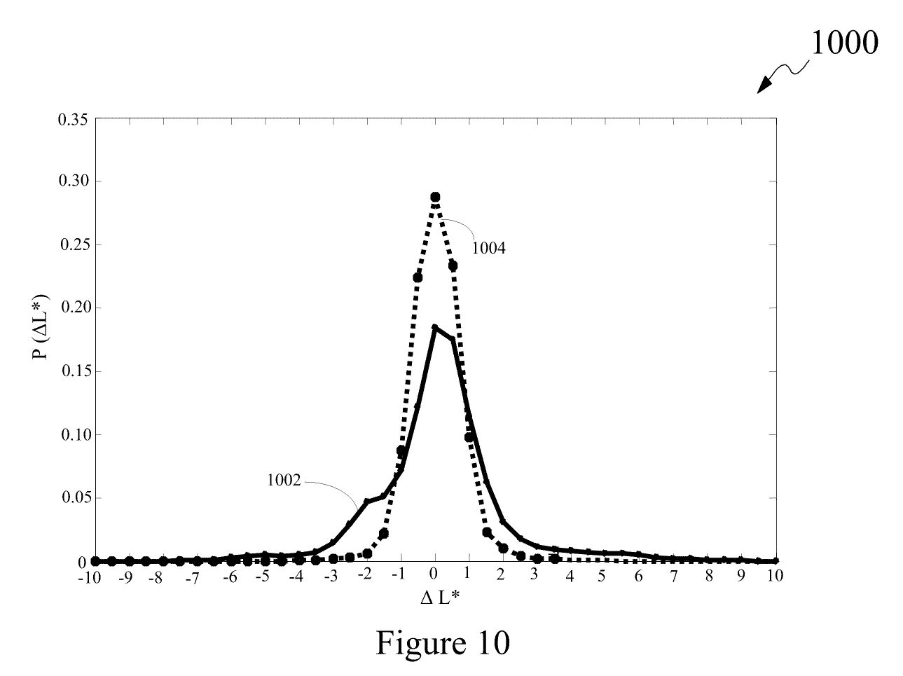

To corroborate the compensation of the imaging defect in defect-compensated image 908, a distribution of values of ΔL* for full-page print 800 of FIG. 8a and for defect-compensated image 908 of FIG. 9b, were plotted against values of ΔL*. Such a distribution is as depicted as distribution 1000 in FIG. 10. As depicted in FIG. 10, a plot of values of deviation of ΔL* for full-page print 800 of FIG. 8a is depicted as plot 1002. Further, a plot of values of deviation of ΔL* for defect-compensated image 908 of FIG. 9b is depicted as plot 1004.

It may be observed from plots 1002 and 1004 that the distribution corresponding to defect-compensated image 908 may be better than the distribution corresponding to full-page print 800. Quantitatively, if we may allow a tolerance of about +1 ΔL* and about −1 ΔL* during the compensation of the imaging defect in the image forming apparatus, then about 72.86 percent of pixels of full-page print 800 met the tolerance values. However, by implementation of method 100 of the present disclosure, about 95.70 percent of pixels of defect-compensated image 908 met the tolerance values. This clearly indicates a marked improvement in the average lightness of the defect-compensated image 908 as compared to the average lightness of the full-page print 800.

### Mathematical Model

The mathematical model employed for compensating the imaging defect in the image forming apparatus, will now be described in greater detail. More specifically, the mathematical model below may be employed for adjusting the photon energy of the light source of the image forming apparatus.

In general, the average lightness (L*) is a function of the photon energy (P). For example, we may define an approximately linear relationship between L* and P as:

L*=aP+b Eq. 1

It should be understood that ‘a’ and ‘b’ as mentioned in the equation 1 may be constants, which define the approximately linear relationship.

Now, it will be apparent to a person skilled in the art that an image rendered by the image forming apparatus may be defined by a two variable function I[x,y], where x and y correspond to the spatial dimensions of a sheet of media. Therefore, we may represent the defect-compensated image formed in the image forming apparatus as:

I_{c} [x, y]=I [x, y]×Compensation Factor Eq. 2

where I[x,y] represents the original image and I_{c} [x, y] is the corrected image.

The compensation factor mentioned in the equation 2 above may in turn be a function of a target value of L* (hereinafter referred to as ‘L*_{Target}’) and the compensating profile. It should be apparent to a person skilled in the art that the compensating profile may also be represented as a two variable function CP [u, v], where u and v represent the spatial dimensions of the page portion corresponding to one period (i.e., circumference) of the PC drum. The compensation factor may be represented as:

Compensation Factor=F_{pow} [L*_{Target|}CP [u, v]] Eq. 3

where F_{pow} is a function that converts the adjusted L* value (i.e., the L*_{Target} plus CP[u,v]) into the corresponding adjustment required in the photon energy. An exemplary F_{pow} may be represented as below:

F_{pow}(L*)=(L*−86)×(−1/0.2)×(P_{Target}/L*_{Target}) Eq. 4

where P_{Target} refers to the target or intended laser power value needed to produce lightness output value L*_{Target}. Equation 4 is derived from the relationship between a laser power value P and its corresponding L*.

Based on the foregoing, the present disclosure provides a method, such as method 100, for compensating an imaging defect of image forming apparatus. Further, the present disclosure provides an image forming apparatus, which implements the method. The method reduces the maintenance costs of the image forming apparatus, and increases levels of satisfaction of users of the image forming apparatus. Further, the method lowers manufacturing costs of PC drums by accepting use of less than uniform PC drums in the image forming apparatus, without suffering from reduced image quality caused by the imaging defects in the image forming apparatus.

The foregoing description of several embodiments and methods of the present invention have been presented for purposes of illustration. It is not intended to be exhaustive or to limit the present invention to the precise steps and/or forms disclosed, and obviously many modifications and variations are possible in light of the above teaching. It is intended that the scope of the present disclosure be defined by the claims appended hereto.

What is claimed is:

1. A method for compensating an imaging defect in an image forming apparatus, the method comprising:
generating a raster image;
determining a compensating profile representing the imaging defect in the image forming apparatus; and
forming a defect-compensated image based on the raster image and the compensating profile.

2. The method of claim 1, wherein forming the defect-compensated image comprises:
applying the compensating profile to the raster image to form a modified raster image;
halftoning the modified raster image to form a halftoned image; and
printing the halftoned image to obtain the defect-compensated image.

3. The method of claim 2 further comprising identifying a predetermined position of a Photoconductor (PC) drum prior to applying the compensating profile to the raster image, the predetermined position identified for synchronizing the PC drum with a Raster Image Processor module (RIP module) of the image forming apparatus.

4. The method of claim 2, wherein the compensating profile is applied to pre-halftoned image pixel values of the raster image.

5. The method of claim 1, wherein forming the defect-compensated image comprises:
halftoning the raster image to form a halftoned image;
adjusting a photon energy of a light source of the image forming apparatus, the photon energy adjusted based on the compensating profile representing the imaging defect; and
printing the halftoned image to form the defect-compensated image.

6. The method of claim 5 further comprising identifying a predetermined position of a Photoconductor (PC) drum prior to printing the halftoned image, the predetermined position identified for synchronizing the PC drum with a Raster Image Processor module (RIP module) of the image forming apparatus.

7. The method of claim 1, wherein determining the compensating profile representing the imaging defect in the image forming apparatus comprises:
printing one or more media in the image forming apparatus;
scanning the one or more media to obtain an electronic profile, the electronic profile comprising a plurality of frequency components; and
processing the electronic profile to obtain the compensating profile, wherein the compensating profile comprises a set of frequency components from the plurality of frequency components.

8. The method of claim 7 further comprising storing the compensating profile in a memory of the image forming apparatus.

9. The method of claim 1, wherein determining the compensating profile comprises receiving the compensating profile from a storage location.

10. An image forming apparatus capable of compensating an imaging defect thereof, the image forming apparatus comprising:
a determining module configured to determine a compensating profile representing the imaging defect; and
an image processing module coupled to the determining module, the image processing module configured to,
generate a raster image, and
form a defect-compensated image based on the raster image and the compensating profile.

11. The image forming apparatus of claim 10, wherein the image processing module comprises:
a Raster Image Processor module (RIP module) configured to,
generate the raster image,
apply the compensating profile to the raster image to form a modified raster image, and
halftone the modified raster image to form a halftoned image; and
a printer module coupled to the RIP module, the printer module configured to print the halftoned image to obtain the defect-compensated image.

12. The image forming apparatus of claim 11, wherein the image processing module further comprising a sensing module coupled to the RIP module and the printer module, the sensing module configured to identify a predetermined position of a Photoconductor (PC) drum of the image forming apparatus, the predetermined position identified to synchronize the PC drum with the RIP module of the image forming apparatus.

13. The image forming apparatus of claim 11, wherein the RIP module is configured to apply the compensating profile to pre-halftoned image pixel values of the raster image.

14. The image forming apparatus of claim 10, wherein the image processing module comprises:
a Raster Image Processor module (RIP module) module configured to,
generate the raster image, and
halftone the raster image to form a halftoned image;
a compensating module configured to adjust a photon energy of a light source of the image forming apparatus, the photon energy adjusted based on the halftoned image and the compensating profile; and
a printer module configured to print the halftoned image to form the defect-compensated image.

15. The image forming apparatus of claim 14, wherein the image processing module further comprising a sensing module coupled to the compensating module and the printer module, the sensing module configured to identify a predetermined position of a Photoconductor (PC) drum of the image forming apparatus, the predetermined position identified to synchronize the PC drum with the RIP module of the image forming apparatus.

16. The image forming apparatus of claim 10, wherein the determining module is configured to determine the compensating profile by:
printing one or more media in the image forming apparatus;
scanning the one or more media to obtain an electronic profile, the electronic profile comprising a plurality of frequency components; and
processing the electronic profile to obtain the compensating profile, wherein the compensating profile comprises a set of frequency components from the plurality of frequency components.

17. The image forming apparatus of claim 16 further comprising a memory to store the compensating profile.
